(19) United States
(12) Patent Application Publication
(10) Pub. No.: US 2018/0115905 A1
(43) Pub. Date: Apr. 26, 2018

(54) LICENSED SHARED ACCESS ARCHITECTURE WITH SPECTRUM SENSING

(71) Applicant: Intel IP Corporation, Santa Clara, CA (US)

(72) Inventor: Alexander Sirotkin, Tel Aviv (IL)

(73) Assignee: Intel Corporation, Santa Clara, CA (US)

(21) Appl. No.: 15/559,326

(22) PCT Filed: Dec. 22, 2015
(86) PCT No.: PCT/US2015/067391

§ 371 Date: Sep. 18, 2017

Related U.S. Application Data
(60) Provisional application No. 62/148,674, filed on Apr. 16, 2015.

(51) Int. Cl. H04W 16/14; H04W 64/00

(52) U.S. Cl. CPC H04W 16/14; H04W 64/00

(57) ABSTRACT

Embodiments of an Apparatus, Components and Circuitry for a controller configuring sensors for sensing available spectrum from incumbent owners and authorizing use and access to one or more permitted users are generally described herein. In some cases, primary usage of the shared spectrum may be prioritized over the secondary usage of the shared spectrum. The controller may receive, from a sensor, various parameters of the incumbent owner's spectrum usage which would indicate spectrum availability for the secondary usage. The controller may, also sense spectrum information that is based at least partly on one or more signal strength measurements for UEs connected to the controller. The controller may further transmit, to an ESC, a spectrum use message that indicates an intention of the controller to use at least a portion of the shared spectrum for communication with the UEs

### CROSS-REFERENCE TO RELATED APPLICATION

This application claims the benefit of U.S. Provisional Patent Application No. 62/148,674, filed Apr. 16, 2015, entitled “LSA ARCHITECTURE WITH SPECTRUM SENSING”, which is incorporated by reference herein in its entirety.

### TECHNICAL FIELD

Embodiments pertain to wireless communications. Some embodiments relate to wireless networks including 3GPP (Third Generation Partnership Project) networks, 3GPP LTE (Long Term Evolution) networks, and 3GPP LTE-A (LTE Advanced) networks, although the scope of the embodiments is not limited in this respect. Some embodiments relate to primary and secondary usage of spectrum, such as shared spectrum. Some embodiments relate to spectrum access detection for shared spectrum.

### BACKGROUND

Licensed Shared Access (LSA) has the potential to increase the use of the radio spectrum by allowing ‘shared access’ by additional parties when and where the primary licensee is not using its designated frequencies. As global demand for spectrum intensifies, new technology is required to share spectrum in areas that are not easily shared due to proprietary technologies or national security in some physical locations.

### BRIEF DESCRIPTION OF THE DRAWINGS

To easily identify the discussion of any particular element or act, the most significant digit or digits in a reference number refer to the figure number in which that element is first introduced.

FIG. 1 illustrates example components of the User Equipment (UE) Device in accordance with some embodiments.

FIG. 2 illustrates a functional diagram of an Evolved Node-B (eNB) in accordance with some embodiments;

FIG. 3 illustrates a block diagram of an example of a controller in accordance with some embodiments;

FIG. 4 illustrates an aspect of general spectrum sharing configuration in accordance with some embodiments;

FIG. 5 illustrates an aspect of the (Citizens Broadband Radio Service) CBRS variant of the solution in accordance with some embodiments;

FIG. 6 illustrates an aspect of the spectrum sensing configuration of the transmission of an incumbent owner, in accordance with some embodiments;

FIG. 7 illustrates an aspect of the incumbent receiver detection in accordance with some embodiments; and

FIG. 8 illustrates a functional diagram of a User Equipment (UE) assisted spectrum sensing in accordance with some embodiments.

### DETAILED DESCRIPTION

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device. The following description and the referenced drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Spectrum sharing is defined as two or more mobile communication systems that operate in the same band. Its attraction as a potential means of improving the overall spectrum usage efficiency has generated a strong interest as the increase of smart phones usage and fast growth of mobile broadband requirements by that and other usage creates a large need for finding new spectrum bands to serve the traffic. However, it is difficult to find new spectrum where there is sufficient availability and good frequency characteristics. At the same time there are certain frequency bands that are reserved for e.g. military, coast guard or other government use where the actual use of the spectrum by the incumbent owner age is typically limited to specific geographic location or times of the day or combinations of the two usage criteria. In wide geographic areas and/or large parts of time the spectrum can be empty of incumbent usage Spectrum sharing is a mobile communications licensing method that allows current spectrum owners (Incumbents) to share their spectrum with mobile network operators (Licensees) according to this regulatory framework (sharing framework) issued by a Regulator. The advantage of spectrum sharing is that Quality of Service (QOS) is supported even with that shared spectrum. This is achieved with help of protection measures, for example the definition of protection, exclusion and restriction zones by the incumbent.

In the US, a shared licensed spectrum program called Citizens Broadband Radio Service (CBRS) is being utilized. This program focuses on sharing spectrum between 3.5-3.7 GHz that will have two levels of service for non-incumbent users. This spectrum has traditionally been utilized for military radar and satellite up links Additionally, this spectrum falls between two established Wi-Fi allocated spectrums. Incumbent users (the Navy and satellite ground stations) will remain on this spectrum range, however most of the US territory is unused by the incumbent owner.

Alternately, in the EU marketplace, shared spectrum licensing is referred to as Licensed Shared access (LSA), or Authorized Shared access (ASA). LSA is a complementary solution for mobile network operators to spectrum when critical incumbent uses cannot be vacated from a frequency band. (For example, the 2.3-2.4 GHz frequency band). The 2.3-2.4 GHz band is harmonized for mobile broadband at international level, but is used by many important services in some European countries, while being hardly used in other countries. As global demand for spectrum intensifies, new technology is required to share spectrum in areas that are not easily shared due to proprietary technologies or national security in some physical locations. The solution described in some embodiments, describes apparatus, instructions and circuitry for discovering and utilizing available spectrum in a LSA/CBRS/or other similarly licensing schema without receiving the spectrum details about an incumbent owner's usage or interaction with the spectrum.

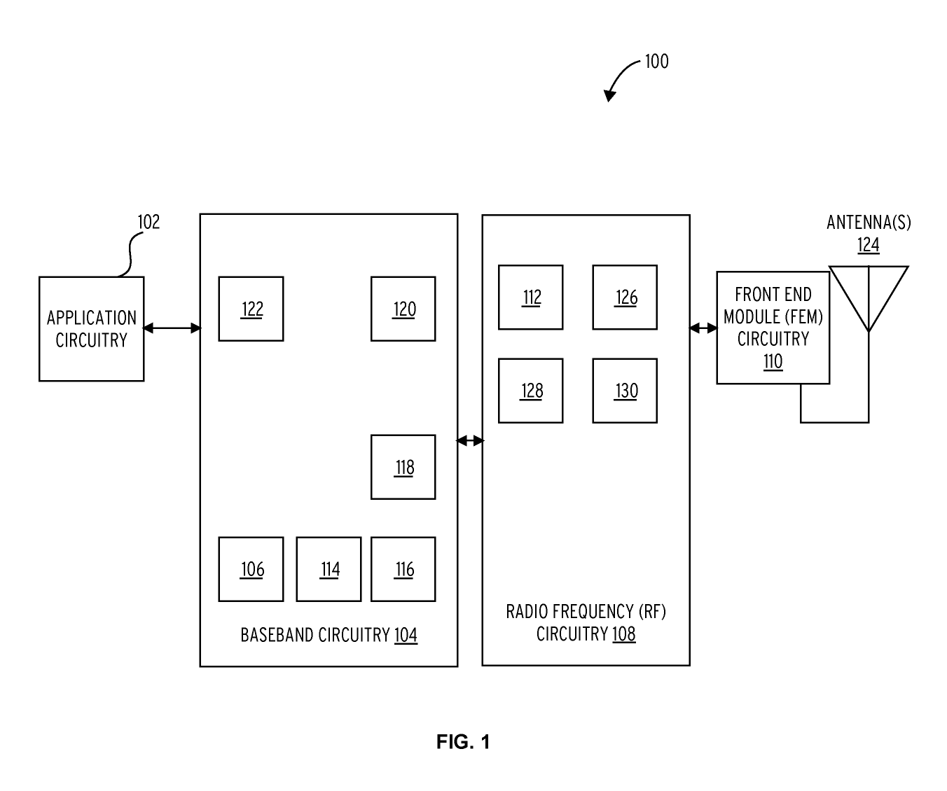

Turning to the Drawings, FIG. 1 illustrates example components of the User Equipment (UE) Device 100 in accordance with some embodiments. In some embodiments, the User Equipment (UE) Device 100 may include Application circuitry 102, Baseb and Circuitry 104, Radio Frequency (RF) circuitry 108, front-end Front End Module (FEM) circuitry 110 and one or more antennas 124, coupled together at least as shown.

The Application circuitry 102 may include one or more application processors. For example, the Application circuitry 102 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The Baseband Circuitry 104 may include circuitry such as, but not limited to, one or more single-core or multi-core processors. The Baseband Circuitry 104 may include one or more baseband processors and/or control logic to process baseband signals received from a receive signal path of the Radio Frequency (RF) circuitry 108 and to generate baseband signals for a transmit signal path of the Radio Frequency (RF) circuitry 108. Baseband Circuitry 104 may interface with the Application circuitry 102 for generation and processing of the baseband signals and for controlling operations of the Radio Frequency (RF) circuitry 108. For example, in some embodiments, the Baseband Circuitry 104 may include a second generation (2G) baseband processor 106, third generation (3G) baseband processor 114, fourth generation (4G) baseband processor 116, and/or other baseband processor(s) 118 for other existing generations, generations in development or to be developed in the future (e.g., fifth generation (5G), 6G, etc.). The Baseband Circuitry 104 (e.g., one or more of baseband processors 106, 114, 116, 618) may handle various radio control functions that enable communication with one or more radio networks via the Radio Frequency (RF) circuitry 108. The radio control functions may include, but are not limited to, signal modulation/demodulation, encoding/decoding, radio frequency shifting, etc. In some embodiments, modulation/demodulation circuitry of the Baseband Circuitry 104 may include Fast-Fourier Transform (FFT), precoding, and/or constellation mapping/demapping functionality. In some embodiments, encoding/decoding circuitry of the Baseband Circuitry 104 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the Baseband Circuitry 104 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 120 of the Baseband Circuitry 104 may be configured to run elements of the protocol stack for signaling of the PHY, MAC, RLC, PDCP and/or RRC layers. In some embodiments, the baseband circuitry may include one or more audio digital signal processor(s) (DSP) 122. The audio DSP(s) 122 may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the Baseband Circuitry 104 and the Application circuitry 102 may be implemented together such as, for example, on a system on a chip (SOC).

In some embodiments, the Baseband Circuitry 104 may provide for communication compatible with one or more radio technologies. For example, in some embodiments, the Baseband Circuitry 104 may support communication with an evolved universal terrestrial radio access network (EUTRAN) and/or other wireless metropolitan area networks (WMAN), a wireless local area network (WLAN), a wireless personal area network (WPAN). Embodiments in which the Baseband Circuitry 104 is configured to support radio communications of more than one wireless protocol may be referred to as multi-mode baseband circuitry.

Radio Frequency (RF) circuitry 108 may enable communication with wireless networks using modulated electromagnetic radiation through a non-solid medium. In various embodiments, the Radio Frequency (RF) circuitry 108 may include switches, filters, amplifiers, etc. to facilitate the communication with the wireless network. Radio Frequency (RF) circuitry 108 may include a receive signal path which may include circuitry to down-convert RF signals received from the FEM circuitry 108 and provide baseband signals to the Baseband Circuitry 104. Radio Frequency (RF) circuitry 108 may also include a transmit signal path which may include circuitry to up-convert baseband signals provided by the Baseband Circuitry 104 and provide RF output signals to the Front End Module (FEM) circuitry 110 for transmission.

In some embodiments, the Radio Frequency (RF) circuitry 108 may include a receive signal path and a transmit signal path. The receive signal path of the Radio Frequency (RF) circuitry 108 may include mixer circuitry 112, amplifier circuitry 126 and filter circuitry 128. The transmit signal path of the Radio Frequency (RF) circuitry 108 may include filter circuitry 128 and mixer circuitry 112. Radio Frequency (RF) circuitry 108 may also include synthesizer circuitry 130 for synthesizing a frequency for use by the mixer circuitry 112 of the receive signal path and the transmit signal path. In some embodiments, the mixer circuitry 112 of the receive signal path may be configured to down-convert RF signals received from the Front End Module (FEM) circuitry 110 based on the synthesized frequency provided by synthesizer circuitry 130.

The amplifier circuitry 126 may be configured to amplify the down-converted signals and the filter circuitry 128 may be a low-pass filter (LPF) or band-pass filter (BPF) configured to remove unwanted signals from the down-converted signals to generate Output baseband signals. Output baseband signals may be provided to the Baseband Circuitry 104 for further processing. In some embodiments, the Output baseband signals may be zero-frequency baseband signals, although this is not a requirement. In some embodiments, mixer circuitry 112 of the receive signal path may comprise passive mixers, although the scope of the embodiments is not limited in this respect.

In some embodiments, the mixer circuitry 112 of the transmit signal path may be configured to up-convert Input baseband signals based on the synthesized frequency provided by the synthesizer circuitry 130 to generate RF Output signals for the Front End Module (FEM) circuitry 110. The baseband signals may be provided by the Baseband Circuitry 104 and may be filtered by filter circuitry 128. The filter circuitry 128 may include a low-pass filter (LPF), although the scope of the embodiments is not limited in this respect.

In some embodiments, the mixer circuitry 112 of the receive signal path and the mixer circuitry 112 of the transmit signal path may include two or more mixers and may be arranged for quadrature down-conversion and/or up-conversion respectively. In some embodiments, the mixer circuitry 112 of the receive signal path and the mixer circuitry 112 of the transmit signal path may include two or more mixers and may be arranged for image rejection (e.g., Hartley image rejection). In some embodiments, the mixer circuitry 112 of the receive signal path and the mixer circuitry 112 may be arranged for direct down-conversion and/or direct up-conversion, respectively. In some embodiments, the mixer circuitry 112 of the receive signal path and the mixer circuitry 112 of the transmit signal path may be configured for super-heterodyne operation.

In some embodiments, the Output baseband signals and the Input baseband signals may be analog baseband signals, although the scope of the embodiments is not limited in this respect. In some alternate embodiments, the Output baseband signals and the Input baseband signals may be digital baseband signals. In these alternate embodiments, the Radio Frequency (RF) circuitry 108 may include analog-to-digital converter (ADC) and digital-to-analog converter (DAC) circuitry and the Baseb and Circuitry 104 may include a digital baseband interface to communicate with the Radio Frequency (RF) circuitry 108.

In some dual-mode embodiments, a separate radio IC circuitry may be provided for processing signals for each spectrum, although the scope of the embodiments is not limited in this respect.

In some embodiments, the synthesizer circuitry 130 may be a fractional-N synthesizer or a fractional N IN+1 synthesizer, although the scope of the embodiments is not limited in this respect as other types of frequency synthesizers may be suitable. For example, synthesizer circuitry 130 may be a delta-sigma synthesizer, a frequency multiplier, or a synthesizer comprising a phase-locked loop with a frequency divider.

The synthesizer circuitry 130 may be configured to synthesize an Output frequency for use by the mixer circuitry 112 of the Radio Frequency (RF) circuitry 108 based on a frequency Input and a divider control Input. In some embodiments, the synthesizer circuitry 130 may be a fractional N IN+1 synthesizer.

In some embodiments, frequency input may be provided by a voltage controlled oscillator (VCO), although that is not a requirement. Divider control Input may be provided by either the Baseband Circuitry 104 or the applications processor in Application circuitry 102 depending on the desired Output frequency. In some embodiments, a divider control Input (e.g., N) may be determined from a look-up table based on a channel indicated by the applications processor in Application circuitry 102.

Synthesizer circuitry 130 of the Radio Frequency (RF) circuitry 108 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the Input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 130 may be configured to generate a carrier frequency as the Output frequency, while in other embodiments, the Output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other.

In some embodiments, the Output frequency may be a LO frequency (fLO). In some embodiments, the Radio Frequency (RF) circuitry 108 may include an IQ/polar converter.

Front End Module (FEM) circuitry 110 may include a receive signal path which may include circuitry configured to operate on RF signals received from one or more antennas 124, amplify the received signals and provide the amplified versions of the received signals to the Radio Frequency (RF) circuitry 108 for further processing. Front End Module (FEM) circuitry 110 may also include a transmit signal path which may include circuitry configured to amplify signals for transmission provided by the Radio Frequency (RF) circuitry 108 for transmission by one or more of the one or more antennas 124.

In some embodiments, the Front End Module (FEM) circuitry 110 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an Output (e.g., to the Radio Frequency (RF) circuitry 108). The transmit signal path of the Front End Module (FEM) circuitry 110 may include a power amplifier (PA) to amplify Input RF signals (e.g., provided by Radio Frequency (RF) circuitry 108), and one or more filters to generate RF signals for subsequent transmission (e.g., by one or more of the one or more antennas 124.

In some embodiments, the User Equipment (UE) Device 100 may include additional elements such as, for example, memory/storage, display, GPS camera, sensor, and/or Input/Output (I/O) interface.

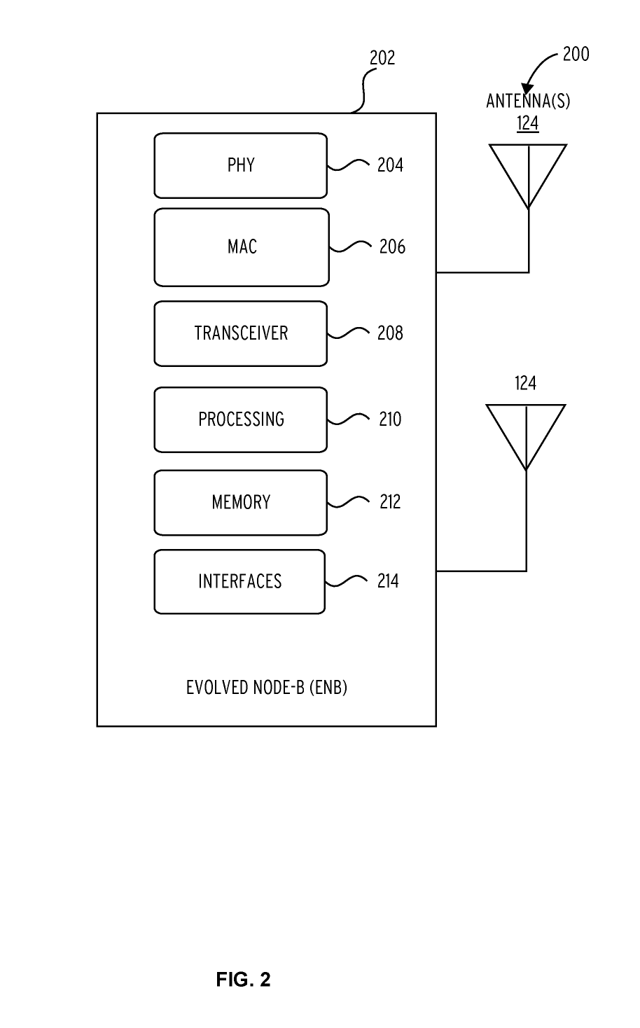

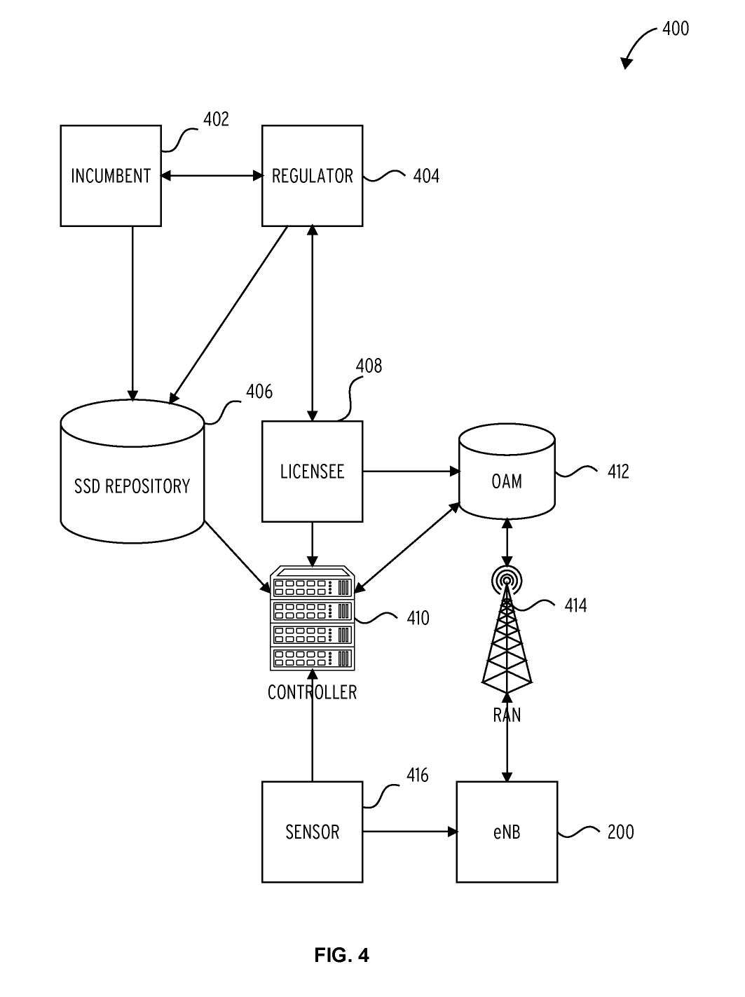

FIG. 2 is a functional diagram of an Evolved Node-B (eNB) in accordance with some embodiments. It should be noted that in some embodiments, the eNB 200 may be a stationary non-mobile device and in others it maybe a device that is in motion. The eNB 200 may be suitable for use as an example eNB 200 as depicted in FIG. 4. The eNB may include physical layer circuitry PHY 204 and a Transceiver 208, one or both of which may enable transmission and reception of signals to and from the User Equipment (UE) Device 100, other eNBs, other UEs or other devices using one or more Antenna 124. As an example, the PHY 204 may perform various encoding and decoding functions that may include formation of baseband signals for transmission and decoding of received signals. As another example, the Transceiver 208 may perform various transmission and reception functions such as conversion of signals between a baseband range and a Radio Frequency (RF) range. Accordingly, the PHY 204 and the Transceiver 208 may be separate components or may be part of a combined component. In addition, some of the functionality described may be performed by a combination that may include one, any or all of the PHY 204, the Transceiver 208, and other components or layers. The eNB 200 may also include medium access control layer MAC 206 for controlling access to the wireless medium. The eNB 200 may also include processing circuitry Processing 210 and Memory 212 arranged to perform the operations described herein. The eNB 200 may also include one or more Interfaces 214, which may enable communication with other components, including other eNBs, components in Spectrum Sharing Configuration 400 (FIG. 4) or other network components. In addition, the Interfaces 214 may enable communication with other components that may not be shown in FIG. 1, including components external to the network. The Interfaces 214 may be wired or wireless or a combination thereof.

The Antenna 124 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the Antenna 124 may be effectively separated to take advantage of spatial diversity and the different channel characteristics that may result.

In some embodiments, the UE 100 or the eNB 200 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the User Equipment (UE) Device 100 or eNB 200 may be configured to operate in accordance with 3GPP standards, although the scope of the embodiments is not limited in this respect. Mobile devices or other devices in some embodiments may be configured to operate according to other protocols or standards, including IEEE 802.11 or other IEEE standards. In some embodiments, the User Equipment (UE) Device 100 eNB 200 or other devices may include one or more of a keyboard, a display, a non-volatile memory port, multiple antennas, a graphics processor, an application processor, speakers, and other mobile device elements. The display may be an LCD screen including a touch screen.

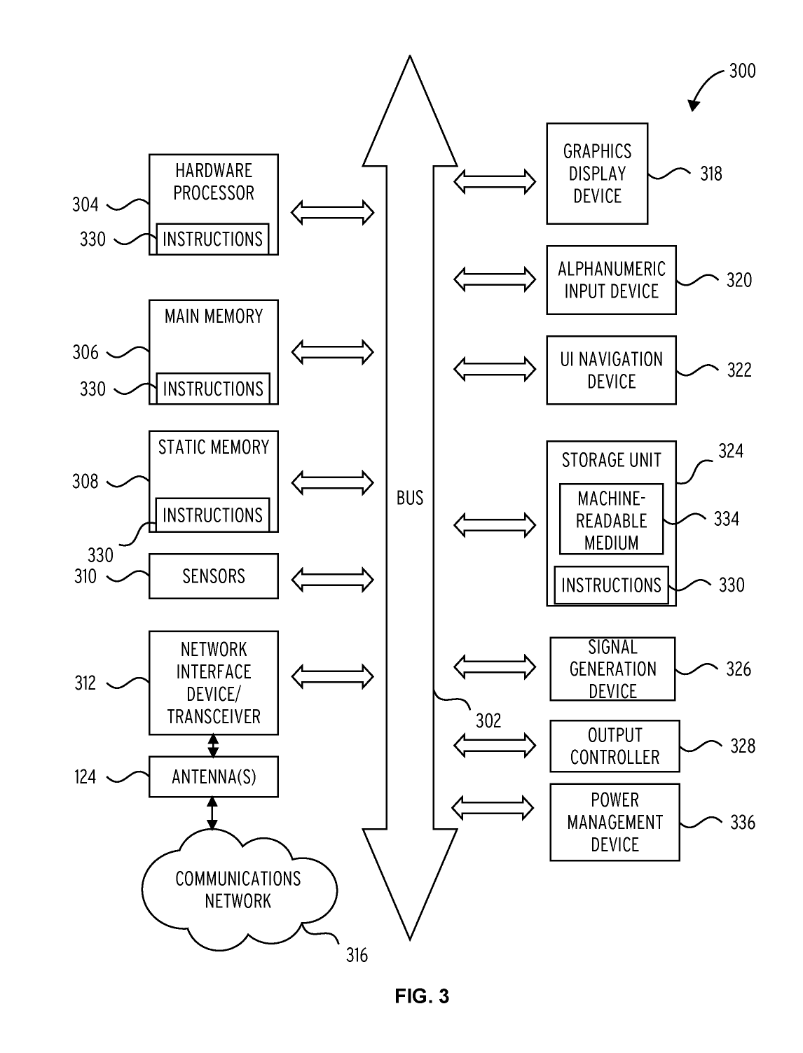

In FIG. 3, the machine 300 illustrates a block diagram of an example of a Controller 410 (FIG. 4) in accordance with some embodiments upon which any one or more of the techniques (e.g., methodologies) discussed herein may be performed. In alternative embodiments, the machine 300 may operate as a standalone device or may be connected (e.g., networked) to other machines. In a networked deployment, the machine 300 may operate in the capacity of a server machine, a client machine, or both in server-client network environments. In an example, the machine 300 may act as a peer machine in peer-to-peer (P2P) (or other distributed) network environment. The machine 300 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine, such as an eNB 200. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., a special purpose computer system) 300 may include a Hardware Processor 304 (e.g., a central processing unit (CPU), a graphics processing unit (GPU), a hardware processor core, or any combination thereof), a Main Memory 306 and a Static Memory 308, some or all of which may communicate with each other via an interlink (e.g., Bus 302.) The machine 300 may further include a Power Management device 336, a Graphics Display Device 318, an Alphanumeric Input Device 320 (e.g., a keyboard), and a user interface (UI Navigation Device 322 (e.g., a mouse). In an example, the Graphics Display Device 318, Alphanumeric Input Device 320 and UI Navigation Device 322 may be a touch screen display. The machine 300 may additionally include a storage device (i.e., Storage Unit 324), a Signal Generation Device 326 (e.g., a speaker), a Network Interface device/Transceiver 312 coupled to Antenna(s) 124, and one or more Sensor 416, such as a global positioning system (GPS) sensor, compass, accelerometer, or other sensor. The machine 300 may include an Output Controller 328, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)

The Storage Unit 324 may include a Machine-Readable Medium 334on which is stored one or more sets of data structures or Instructions 330 (e.g., software) embodying or utilized by any one or more of the techniques or functions described herein. The Instructions 330 may also reside, completely or at least partially, within the Main Memory 306, within the Static Memory 308, or within the Hardware Processor 304 during execution thereof by the machine 300. In an example, one or any combination of the Hardware Processor 304, the Main Memory 306, the Static Memory 308, or the Storage Unit 324 may constitute machine readable media.

While the Machine-Readable Medium 334 is illustrated as a single medium, the term “machine readable medium” may include a single medium or multiple media (e.g., a centralized or distributed database, and/or associated caches and servers) configured to store the one or more Instructions 330.

The term “machine readable medium” may include any medium that is capable of storing, encoding, or carrying instructions for execution by the machine 300 and that cause the machine 300 to perform any one or more of the techniques of the present disclosure, or that is capable of storing, encoding or carrying data structures used by or associated with such instructions.

Non-limiting machine readable medium examples may include solid-state memories, and optical and magnetic media. In an example, a massed machine readable medium comprises a machine readable medium with a plurality of particles having resting mass. Specific examples of massed machine readable media may include: non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The Instructions 330 may further be transmitted or received over a Communications Network 316 using a transmission medium via the Network Interface device/Transceiver 312 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as

Wi-Fi®, IEEE 802.16 family of standards known as WiMax®), IEEE 802.15.4 family of standards, and peer-to-peer (P2P) networks, among others. In an example, the Network Interface device/Transceiver 312 may include one or more physical jacks (e.g., Ethernet, coaxial, or phone jacks) or one or more antennas to connect to the Communications Network 316. In an example, the Network Interface device/Transceiver 312 may include a plurality of Antenna(s) 124 to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 300, and includes digital or analog communications signals or other intangible media to facilitate communication of such software.

FIG. 4 illustrates an aspect of general Spectrum Sharing Configuration 400 in accordance with some embodiments and their constituents and hardware. The principal entities in the spectrum sharing concept comprise the Incumbent 402 who generally holds control of the spectrum, the Licensee 408 who seeks to license the spectrum and the Regulator 404 who administrates access to the spectrum. In the general case, there can be several Incumbent 402 users and several Licensee 408 participants. The different participants of Incumbent 402, can be generally classified into governmental and commercial spectrum holders. The Incumbent 402 offers its unused spectrum to be shared with one or more Licensee 408 entities and negotiates the usage conditions with the Licensee 408 according to the framework defined by the Regulator 404.

Alternatively, the Regulator 404 could ask the Incumbent 402 to release its unused spectrum to be shared to a Licensee 408. To illustrate this general approach simply, the licensing approach is shown as binary in nature, indicating that one part of the spectrum band is intended to be licensed to one Licensee 408 at a time in a specific regional area. Some embodiments would also include multiple Incumbent 402 participants and/or multiple Licensee 408 participants. The Regulator 404 is responsible for defining the framework for the licensing rules and awarding the license rights to the Licensee 408. The Licensee 408 shares the spectrum with the Incumbent 402 after obtaining the license; following the sharing rules and conditions agreed to with the Incumbent 402. The actual rules depend on how the Incumbent 402 systems are to be protected. The spectrum sharing approach requires new hardware elements compared to traditional spectrum access on exclusively licensed bands. This hardware is denoted as Spectrum Sharing Data (SSD) repository 406 and Controller 410. The SSD repository 406 includes information about available spectrum for the Licensee 408 to use based on the information about the Incumbent 402 spectrum use. The Controller 410 is responsible for controlling the access to the spectrum made available for the Licensee 408 based on rules of the spectrum sharing license and information on the Incumbent 402 spectrum use from the SSD repository 406. The SSD repository 406 and Controller 410 provide authentication and authorization to protect and secure the network related data. Information about available spectrum bands and their usage conditions are fed into the SSD repository 406. The Licensee 408 obtains knowledge of the permitted spectrum bands from the SSD repository 406 via the Controller 410. The Licensee 408 then utilizes the operations administration and management module (OAM) 412 to plan and configures its radio access network (RAN) 414 and sends instructions to the eNB to access to User Equipment (UE) Device 100. In the present solution, where the Incumbent 402 is concealing much of the underlying data held in the SSD repository 406, a standard configuration approach will not work. In this case the Licensee 408 uses a Sensor 416 for sensing the spectrum that is available in a physical location that the Incumbent 402 is making available. In this case, the Incumbent only provides a physical location (geographic, relative, offset or other location coordinates) where the spectrum is to be sensed rather than providing other parameters of data that are regarded as sensitive, secret or proprietary by the Incumbent 402. The Sensor 416 can be any Radio Frequency (RF) sensor capable of measuring RF characteristics or features from a wireless transmitter or a wireless receiver that leaks wireless power. The Sensor 416 acts in concert with the Controller 410 is at a minimum, capable of sensing spectrum holes(i.e. detecting if a spectrum is being utilized), determining if the Incumbent 402 is present and utilizing spectrum, detecting if a Licensee 408 is present and utilizing spectrum, and detecting the availability of channels. If the Sensor 416 is co-located with the eNB 200, then the Sensor 416 position is fixed in the area where sensed licensed spectrum is required and may be used as a spectrum detector. Alternatively, the Sensor 416 can be located at an offset to the eNB 200 or co-located with the Controller 410 if their location is different than the eNB 200 The Controller 410 receives the Sensor 416 Input and allocates spectrum according to SSD repository 406 rules and amended by the spectrum availability sensed by the Sensor 416 obtains knowledge of the permitted spectrum bands from the via the Controller 410. The Licensee 408 then utilizes the OAM 412 to plan and configures its radio access network (RAN) 414 In the present solution, the Incumbent 402 may want to protect much of the underlying data held in the SSD repository 406. In this case the Licensee 408 must also sense the spectrum that is available in a physical location that the Incumbent 402 is making available.

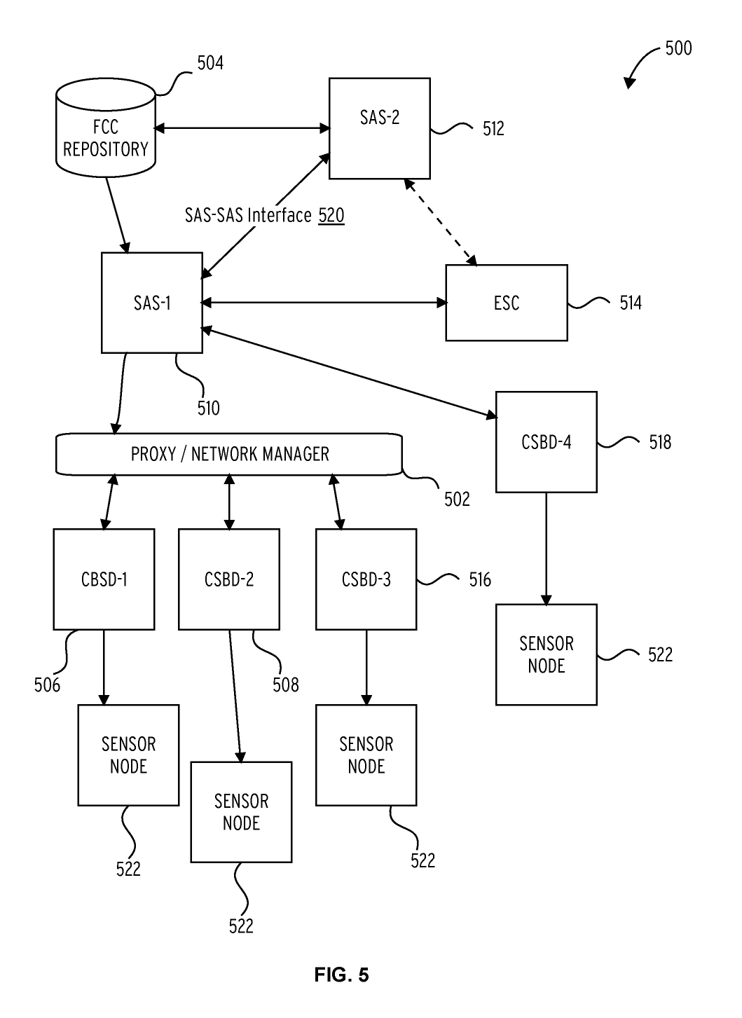

FIG. 5 illustrates an aspect of the Citizens Broadband Radio Service (CBRS) variant of the solution in accordance with some embodiments. This system architecture governing the CBRS system, a spectrum sharing scheme for the United States that describes a prioritized spectrum overlay model, certain users are assigned priority access privileges and certain users are assigned the secondary access by these services. Other non-prioritized secondary spectrum users will vacate the spectrum if a priority user wishes to access spectrum. The CBRS contemplates a tier holding priority access licensees (PALs) and a second tier for general authorized access (GAA) which is unlicensed. Also in the case where the sensed licensed spectrum is made available to different tiered users including unlicensed access by a General Access (GAA.) In the case of interference, the SAS-1 510 also removes a GAA user when an authorized User (PAL) requests access to the sensed license spectrum.

The CBRS system is managed by a spectrum manager and scheduler called the Spectrum Access System (SAS). The SAS manages interference to incumbents by the other tiers, the interference between the same tiers User Equipment (UE) Device 100 and as well as a prioritized tier over a general access tier. There can be more than one SAS as shown in FIG. 5. In this case SAS-1 510 is supported by the Environment Sensing Component (ESC) 214. The ESC 514 is used sense every channel in the shared spectrum range. The ESC 514 architecture includes an incumbent detection capability that monitors for incumbent activity and alerts SAS to reallocate to channels/spectrum to avoid Incumbent Interference. The information from ESC 514 and FCC repository 504 enable the SAS-1 510 to effectively provide dynamic channel allocation to different levels of users, and ensure the Quality of Service (QoS) for different tiers, and enforce the protection requirements set by FCC. This solution in some embodiments, functions as the ESC 514. In other embodiments, this solution functions as a supplement or complementary service to the ESC. Different SASs (for example SAS-1510 or SAS-2 512) operating in this band could communicate with each other through the SAS-SAS Interface 520. The SASs can act independently or in tandem to help keep the Incumbent user of the spectrum clear of interference, while the other SAS predicts and manages the dynamic allocation of spectrum to the various tiers of users. The SAS-SAS Interface 520 interface allows sharing the databases content, channel allocation, load balancing interference management of CBRS to enable each SAS to perform its management functionalities more efficiently. The Citizens Broadband Radio Service Devices (CBSDs) can use the spectrum in this band, only if they are authorized by SAS-1 510 to operate. The CBSD are fixed access points operating in this service. Each CBSD registers and authenticates with the SAS-1 510 before being able to operate in this band. The CBSD-4 518 could either communicate with the SAS1 510 directly, or through a Proxy/Network Manager 502 as shown by CBSD-1 506 or CBSD-2 508 or CBSD-3 516. The Proxy/Network manager 502 function is to accept a set of available channels and allocate channels for each CBSD and perform bidirectional information processing and routing. (e.g., interference reporting) Each of the CBSDs using the spectrum using the current solution will utilize a Sensor Node 522 to locate and identify an Incumbent using the shared spectrum. The Sensor Node 522 can comprise a Sensor 416 and an eNB 200 among other components. The current solution uses one or more Sensor Node 522 to help diminish issues of multi-path propagation or shadowing. Using one or more Sensor Node 522 is a proposed solution to the problems that arise during spectrum sensing like fading, shadowing and receiver uncertainty. A large network of CBSDs with sensing information exchanged between each CBSD will have a better chance of detecting the Incumbent 402 use of the reserved spectrum when compared to individual Sensor Node 522 in any CBSD.

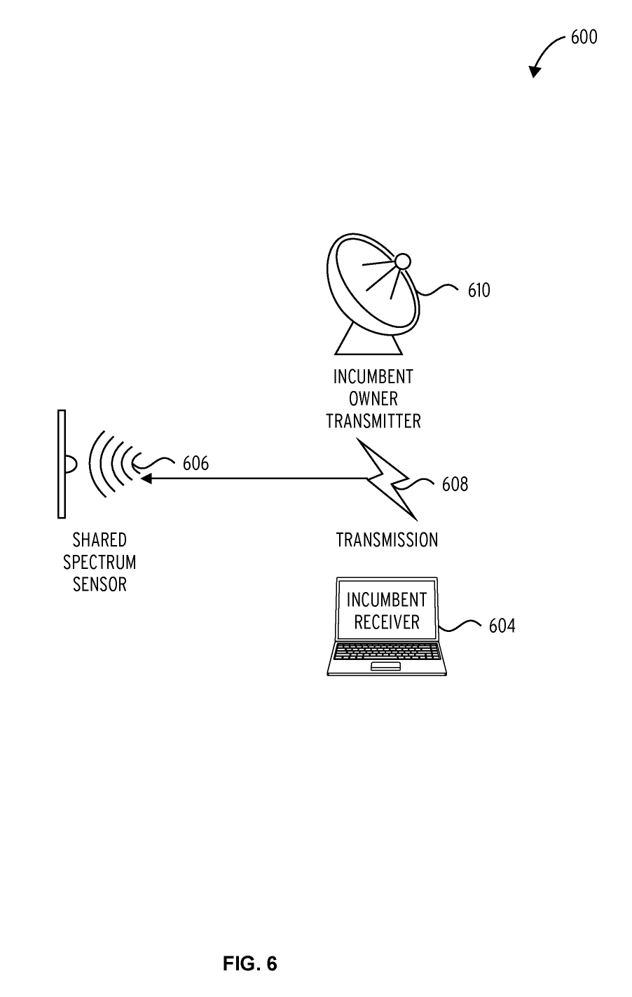

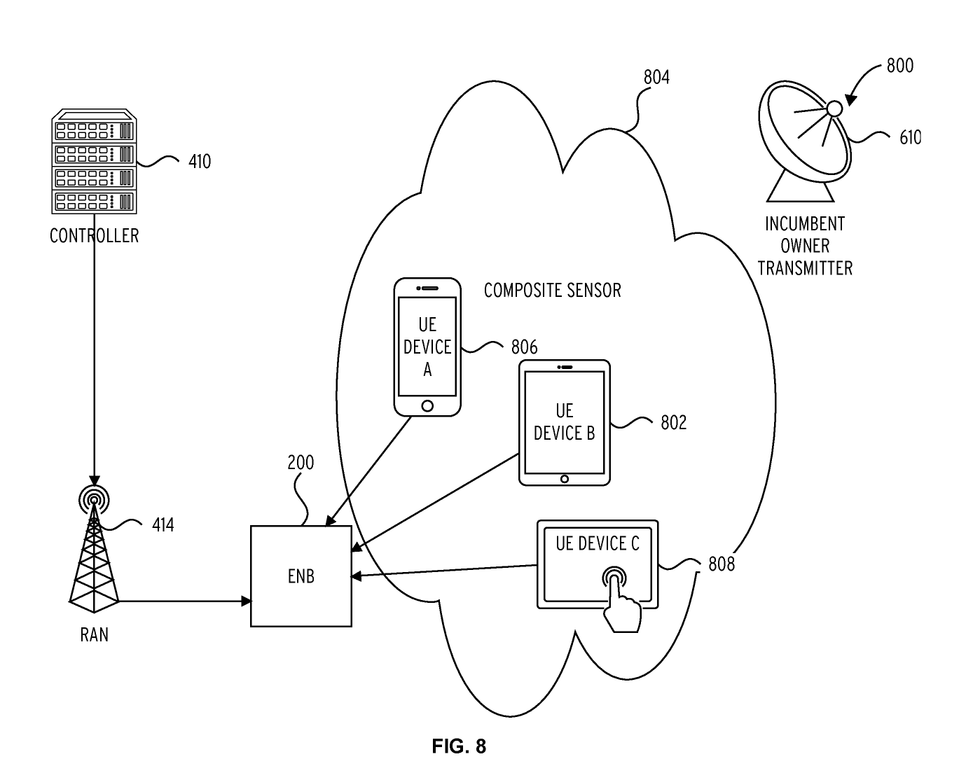

FIG. 6 illustrates an aspect of the spectrum sensing configuration of the transmission of an incumbent owner, in accordance with some embodiments. A Spectrum Sensing Configuration 600 is shown. The Shared Spectrum Sensor 606 senses the RF-environment in order to detect the presence of an Incumbent Owner Transmitter 610, determine its physical location, and estimate the transmit-power and active transmission by the Incumbent Owner Transmitter 610. In transmitter detection, in order to distinguish between used and unused spectrum bands, licensee distinguishes their own signal from an Incumbent Owner Transmitter 610. The Shared Spectrum Sensor 606 observes the Transmission 608 of the Incumbent Owner Transmitter 610 and can comprise a Sensor 416 (as described in FIG. 4.), a Sensor Node 522(as described in FIG. 5), a Composite Sensor (as described in FIG. 8) or other configurations of sensing devices. Incumbent Owner Transmitter 610 sensing can be discovered by utilizing several methods that include a) Matched Filter Detection, b) Energy Detection, or c) Features Detection. Some embodiments utilize a mixture of detection techniques.

Matched Filter Detection: Matched filter detection uses the linear optimal filter that is used for signal detection to maximize the signal-to-noise ratio. It is obtained by correlating a known original Incumbent Transmission 608 signal s(t) with a received signal r(t) where T is the symbol duration of the Incumbent Transmission 608 signals. The output of the matched filter is sampled at the synchronized timing. If the sampled value is greater than the threshold value, the spectrum is determined to be occupied by the Incumbent Transmission 608. Similar detection processes can be used to distinguish Licensee 408 types and service tiers.

Energy detection: Energy detection is used to detect an unknown signal if the noise power is known. In the energy detection, Licensee 408 sense the presence/absence of the Incumbent 402 based on the energy of the received signals. Here, the measured signal r(t) is squared and integrated over the observation interval T. The output of the integrator is compared with a threshold value to decide if an Incumbent 402 is present.

Features detection: Features detection identifies the presence of Incumbent 402 signals by extracting their specific features such as pilot signals, cyclic prefixes, symbol rate, spreading codes, or modulation types from provided or by local observation. These features introduce built-in patterns in the modulated signals, which can be detected by analyzing a spectral correlation function. The feature detection leverages this spectral correlation function. The spectrum correlation of the received signal r(t) is averaged over the interval T, and compared versus a benchmark statistic to determine the presence of Incumbent 402 signals much in the same manner as to energy detection. An advantage that feature detection has over energy detection is that it can distinguish the signals from different networks or different Incumbent 402. It also allows the sensed licensed spectrum to be maintained without a synchronization between sensing operations of different eNBs

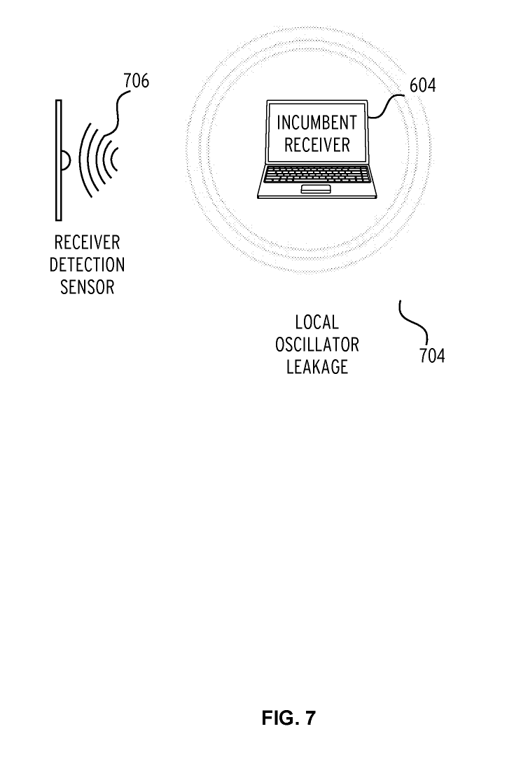

FIG. 7 illustrates an aspect of the Incumbent Receiver 604 detection in accordance with some embodiments. A Receiver Detection Sensor 706 that senses the Incumbent Receiver 604 in the case where the Incumbent Receiver 604 leaks power labeled as Local Oscillator Leakage 704. This phenomenon is common in RF receivers as they will emit to allow other Incumbent Receiver 604 to locate each other. A Receiver Detection Sensor 706 can comprise a Sensor 416 (as shown in FIG. 4) or a Sensor Node 522 (as shown in FIG. 5), a Composite Sensor (as described in FIG. 8) or other configurations of sensing devices.

In this case the Receiver Detection Sensor 706 is positioned in local proximity to the Incumbent Receiver 604 and is capable of detecting when the local equipment or devices of the Incumbent 402 is being utilized. This is useful in the scenario where the Incumbent Owner Transmitter 610 signal is not able to be sensed by other Sensor 416 working in the shared spectrum. This allows a temporal sensing of use by Incumbent Receiver 604 to supplement other licensed spectrum sensing and to avoid interfering with Incumbent 402 use.

UE assisted spectrum sensing: As shown in FIG. 8, other embodiments of the present solution would allow the Controller 410 to configure antennas of a User Equipment (UE) Device 100 to act collectively as a Sensor Node 522. As each UE (e.g. UE Device A 806, UE Device B 802, UE Device C 808) having a GPS device as part of their features, the Controller 410 can instruct the UE devices to sample the frequency spectrum, strength, or features and report back to the Controller 410 aspects of the spectrum in conjunction with the UE device physical location. Correspondingly, if the Incumbent Owner Transmitter 610 is not detectable by the User Equipment (UE) Device 100 then a similar configuration could be established to sense Incumbent Receiver 604 if known physical location of receivers are available.

Advantages of utilizing multiple UE configured to sense the licensed spectrum allows the Controller 410 to virtualize a Composite Sensor 804 made of many UE Devices. The Composite Sensor 804 will have a better sensed understanding of the licensed spectrum and the its use by the Incumbent 402 and Licensee 408 as well as handling issues of shadowing, fading and uncertain signal interpretation. The Composite Sensor 804, if sufficiently dense with UE devices, reduces hidden node problems and has more accurate signal detection.

Each UE calculates its own local sensing that are independently communicated to the Controller 410. The Controller 410 integrates the measurements by collective UE devices and makes a determination of whether the Incumbent 402 is present and utilizing spectrum.

As the quantum and quality of individual UE devices is generally varied in any area, the Controller 410 makes a determination if a Sensor 416, or a Composite Sensor 804 should be utilized or some combination of sensing devices

### EXAMPLES

### Example 1

In some embodiments, an apparatus may include a controller in communication with a (Evolved Node-B) eNB, the controller configured by a received data parameter that defines a location of a sensed licensed spectrum for the eNB, the controller actuates a sensor co-located with the eNB to detect an availability of the sensed licensed spectrum for the eNB, and/or the controller configures the eNB in accord with the availability of the sensed licensed spectrum identified by the sensor.

### Example 2

In some embodiments, the received data parameter also may include a location related to an incumbent owner transmitter.

### Example 3

In some embodiments, the received data parameter also may include a location related to an incumbent owner receiver.

### Example 4

In some embodiments, the controller further configures a Global Positioning System (GPS) location device co-located with the eNB to return a location of the eNB.

### Example 5

In some embodiments, the location of the eNB is variable.

### Example 6

In some embodiments, the controller also configures an access for the eNB based on a received license permission.

### Example 7

In some embodiments, the controller further configures access to an at least one UE to sense the availability of the sensed licensed spectrum.

### Example 8

In some embodiments, the controller further configures the at least one UE to detect a strength of the sensed licensed spectrum.

### Example 9

In some embodiments, the controller configures an unlicensed access for the eNB from an access request associated with an unlicensed UE.

### Example 10

In some embodiments, the controller terminates the unlicensed access for the eNB upon receipt of a licensee request for a licensed access to the sensed licensed spectrum.

### Example 11

In some embodiments, an apparatus where the controller configures at least two eNB to determine the availability of the sensed licensed spectrum.

### Example 12

In some embodiments, an apparatus that includes any combination of features of the Examples 1-11.

### Example 13

In some embodiments, a non-transitory computer-readable storage medium that stores instructions may be for execution by one or more processors to perform operations for communication by a controller, the operations to configure the one or more processors to: receive, from a sensor, a shared licensed spectrum availability for a shared spectrum that is at least partly reserved for priority usage by a one or more incumbent devices, transmit a data message to a mobile device in at least a portion of the shared spectrum, receive, from the sensor, a shared licensed spectrum unavailability that indicates a use of the shared spectrum by the incumbent devices, pause transmission of a second data message to the mobile device in the shared spectrum.

### Example 14

In some embodiments, the non-transitory computer-readable storage medium where the controller also receives, a location of the one or more incumbent devices.

### Example 15

In some embodiments, the controller configures at least a single UE to operate as the sensor.

### Example 16

In some embodiments, the controller configures at least a UE to report a physical location of the UE.

### Example 17

In some embodiments, the controller resumes the transmission of the data message when the controller receives from the sensor, the shared licensed spectrum availability for the shared spectrum.

### Example 18

In some embodiments, the controller is further configured for communication with a UE wherein the shared licensed spectrum availability is determined by the sensor and in accordance with any combination of other features of Examples 13-17.

### Example 19

In some embodiments, an apparatus may include a sensor node co-located with an at least one CBRD that is enabled to detect a shared licensed spectrum when the at least one CBRD is co-located at a physical location where a shared licensed spectrum availability is not provided by an incumbent owner and/or the at least one CBRD receives a parameter that defines the physical location where the shared licensed spectrum is sensed from a first SAS.

### Example 20

In some embodiments, such an apparatus may further include the at least one CBRD also receives a permission from the first SAS that describes a licensee access right.

### Example 21

In some embodiments, such an apparatus may further include the at least one CBRD receives a permission from the first SAS that describes an access right for an unlicensed access.

### Example 22

In some embodiments, the at least one CBRD further receives the parameter that defines the physical location where the shared sensed licensed spectrum is sensed from a network manager.

### Example 23

In some embodiments, a permission is received from an ESC.

### Example 24

In some embodiments, the first SAS transmits the shared licensed spectrum availability to an ESC.

### Example 25

In some embodiments, a second SAS senses the shared licensed spectrum availability, and provides a status to the first SAS.

### Example 26

In some embodiments, an apparatus according to any one of Examples 19 to 25 wherein the first SAS is further configured for communication with a UE wherein the shared licensed spectrum availability is determined by the sensor node.

### Example 27

In some embodiments, a non-transitory computer-readable storage medium that stores instructions may be for execution by one or more processors to perform operations for communication by a first SAS, the operations to configure the one or more processors to:.

### Example 28

In some embodiments, receive, from a sensor node, a shared licensed spectrum availability for a shared spectrum that is at least partly reserved for priority usage by a one or more incumbent devices; transmit a data message to a UE in at least a portion of the shared spectrum; receive, from the sensor node, a shared licensed spectrum unavailability that indicates a use of the shared spectrum by the incumbent devices; and pause transmission of a second data message to the UE in the shared spectrum.

### Example 29

In some embodiments, an at least one CBRD interfaces directly with the first SAS.

### Example 30

In some embodiments, an at least one CBRD interfaces to the first SAS via a network manager.

### Example 31

In some embodiments, an ESC also receives the shared licensed spectrum availability from the sensor node.

### Example 32

In some embodiments, a second SAS provides a physical location to the first SAS to configure the shared licensed spectrum availability from the sensor node.

### Example 33

In some embodiments, the shared licensed spectrum availability is transmitted in a status data message to an ESC.

### Example 34

In some embodiments, the shared licensed spectrum unavailability is transmitted in a status data message to an ESC.

### Example 35

according to any one of Examples 28 to 34 wherein the first SAS is further configured for communication with a UE wherein the shared licensed spectrum availability is determined by the sensor node.

The Abstract is provided to allow the reader to ascertain the nature and gist of the technical disclosure. It is submitted with the understanding that it will not be used to limit or interpret the scope or meaning of the Examples. The following claims are hereby incorporated into the detailed description, with each claim standing on its own as a separate embodiment.

1-30. (canceled)

31. An apparatus comprising:
a controller in communication with a (Evolved Node-B) eNB;
the controller configured by a received data parameter that defines a location of a sensed licensed spectrum for the eNB;
the controller actuates a sensor co-located with the eNB to detect an availability of the sensed licensed spectrum for the eNB; and
the controller configures the eNB in accord with the availability of the sensed licensed spectrum identified by the sensor.

32. An apparatus according to claim 31, wherein the received data parameter also comprises a location related to an incumbent owner transmitter.

33. An apparatus according to claim 31, wherein the received data parameter also comprises a location related to an incumbent owner receiver.

34. An apparatus according to claim 31 wherein the controller further configures a Global Positioning System (GPS) location device co-located with the eNB to return a location of the eNB.

35. An apparatus according to claim 34, wherein the location of the eNB is variable.

36. An apparatus according to claim 31, wherein the controller also configures an access for the eNB based on a received license permission.

37. An apparatus according to claim 31 wherein the controller further configures access to an at least one (User Equipment) UE to sense the availability of the sensed licensed spectrum.

38. An apparatus according to claim 37 wherein the controller further configures the at least one UE to detect a strength of the sensed licensed spectrum.

39. An apparatus according to claim 31, wherein the controller configures an unlicensed access for the eNB from an access request associated with an unlicensed UE.

40. An apparatus according to claim 39, wherein the controller terminates the unlicensed access for the eNB upon receipt of a licensee request for a licensed access to the sensed licensed spectrum.

41. An apparatus according to claim 31 where the controller configures at least two eNB to determine the availability of the sensed licensed spectrum.

42. A non-transitory computer-readable storage medium that stores instructions for execution by one or more processors to perform operations for communication by a controller, the operations to configure the one or more processors to:
receive, from a sensor, a shared licensed spectrum availability for a shared spectrum that is at least partly reserved for priority usage by a one or more incumbent devices;
transmit a data message to a mobile device in at least a portion of the shared spectrum;
receive, from the sensor, a shared licensed spectrum unavailability that indicates a use of the shared spectrum by the incumbent devices; and
pause transmission of a second data message to the mobile device in the shared spectrum.

43. The non-transitory computer-readable storage medium of claim 42 where the controller also receives, a location of the one or more incumbent devices.

44. The non-transitory computer-readable storage medium of claim 42 wherein the controller configures at least a single UE to operate as the sensor.

45. The non-transitory computer-readable storage medium of claim 42 wherein the controller configures at least a UE to report a physical location of the UE.

46. The non-transitory computer-readable storage medium of claim 42 wherein the controller resumes the transmission of the data message when the controller receives from the sensor, the shared licensed spectrum availability for the shared spectrum.

47. An apparatus comprising:
a sensor node co-located with an at least one (Citizens Band Radio Device) CBRD that is enabled to detect a shared licensed spectrum when the at least one CBRD is co-located at a physical location where a shared licensed spectrum availability is not provided by an incumbent owner; and
the at least one CBRD receives a parameter that defines the physical location where the shared licensed spectrum is sensed from a first (Spectrum Access System) SAS.

48. The apparatus of claim 47 further comprising the at least one CBRD also receives a permission from the first SAS that describes a licensee access right.

49. The apparatus of claim 47 further comprising the at least one CBRD receives a permission from the first SAS that describes an access right for an unlicensed access.

50. The apparatus of claim 47 wherein the at least one CBRD further receives the parameter that defines the physical location where the shared sensed licensed spectrum is sensed from a network manager.

51. The apparatus of claim 47 wherein a permission is received from an (Environmental Sensing Component) ESC.

52. The apparatus of claim 47 wherein the first SAS transmits the shared licensed spectrum availability to an ESC.

53. The apparatus of claim 47 wherein a second SAS senses the shared licensed spectrum availability; and provides a status to the first SAS.

54. A non-transitory computer-readable storage medium that stores instructions for execution by one or more processors to perform operations for communication by a first SAS, the operations to configure the one or more processors to:
receive, from a sensor node, a shared licensed spectrum availability for a shared spectrum that is at least partly reserved for priority usage by a one or more incumbent devices;
transmit a data message to a (User Equipment) UE in at least a portion of the shared spectrum;
receive, from the sensor node, a shared licensed spectrum unavailability that indicates a use of the shared spectrum by the incumbent devices; and
pause transmission of a second data message to the UE in the shared spectrum.

55. The non-transitory computer-readable storage medium of claim 54 wherein an at least one CBRD interfaces directly with the first SAS.
